(19) United States
(12) Patent Application Publication
(10) Pub. No.: US 2018/0077987 A1
(43) Pub. Date: Mar. 22, 2018

(54) Method for Designing Garments Using Garment Graph Programming

(71) Applicants: Hyeong-Seok KO, Seoul (KR); Moon-Hwan JEONG, Seoul (KR)

(72) Inventors: Hyeong-Seok KO, Seoul (KR); Moon-Hwan JEONG, Seoul (KR)

(21) Appl. No.: 14/673,762

(22) Filed: Mar. 30, 2015

(51) Int. Cl. A41H 3/00; G06F 17/50; G06T 19/20

(52) U.S. Cl. CPC A41H 3/007; G06F 17/50; G06F 17/5009; G06F 3/04842; G06F 2217/32; G06T 2210/16; G06T 19/20

(57) ABSTRACT

A method for define a dress using concepts of programming language is provided, which uses graph instead of language. Although it is graph-based, the internal operation of the method is similar to text-based programming. The method comprises steps for providing a database or an asset for a garment, providing at least one prototype garment for the garment including principal panels, uploading the prototype garment on a graph window by selecting and associating a principal panel from the asset for each part of the garment, selecting from corresponding assets and adding one or more non-principal panels to the principal panels, programming the garment graph by associating one or more predetermined operations to be applied to each of the principal panels based on a fitting-target body, compiling the programmed garment graph and constructing the garment, and displaying the constructed garment as fitted a mannequin in a garment window.

### REFERENCE TO RELATED APPLICATIONS

This application is a Non-provisional application of, and claims priority to U.S. Patent Provisional App. Ser. No. 61/973,157 filed Mar. 31, 2014.

### BACKGROUND OF THE INVENTION

The present invention relates to a method for designing garments using programming. More particularly, this invention relates to a method for designing garments using computer programming style idea.

A need for a method for designing garments using programming has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a method for designing garments.

The method comprises steps for:

providing a database or an asset for a garment, wherein the asset comprises a plurality of choices for each of a plurality of operands for the garment;

providing at least one prototype garment for the garment including principal panels, wherein the prototype garment is configured to fit a standard body;

uploading the prototype garment on a graph window by selecting and associating a principal panel from the asset for each part of the garment so as to construct a garment graph using graphical representations for principal panels or editing the prototype garment by selecting and associating a principal panel from the asset for each part of the garment;

selecting from corresponding assets and adding one or more non-principal panels to the principal panels;

programming the garment graph by associating one or more predetermined operations to be applied to each of the principal panels based on a fitting-target body;

compiling the programmed garment graph and constructing the garment; and

displaying the constructed garment as fitted a mannequin in a garment window.

The method may further comprise a step for adding a GUI on top of the compiled garment graph before the step for displaying.

The method may further comprise a step for adding or editing marks and handles to the panels for combining with drafts and assets. A mark comprises a 2D coordinate frame and configured for aligning panel/draft, panel/panel, or draft/draft, and a handle is an ordered pair of two marks and configured for assigning a directional line between the two marks.

Each of the principal panel may include a pure version omitting details, a simulation version, a visualization version, and a manufacturing version having every detail of the principal panel.

The step of programming the garment graph may comprise to perform a smart grading technique for accommodating a body difference between the standard body and the fitting-target body on an information processing device.

The principal panels may be visualize all the time, and the non-principal panels are visualized selectively.

The method may further comprise a step for pattern-making and manufacturing the garment based on the constructed garment having the manufacturing version of principal panels and non-principal panels.

The garment graph may comprise a center box for representing the garment and configured for being clickable for compiling, corresponding principal panels connected to and associated with the center box graphically, corresponding non-principal panels connected and associated with corresponding principal panel graphically, and corresponding operands defining how associated panel is modified or replaced.

The operand may be associated with inputs, arguments, and outputs using arrows.

The step for compiling may comprise steps for producing a simulation version of resultant garment, producing a visualization version to show the simulated version, and saving a manufacturing version into a file for the information processing device using a garment graph compiler.

The one or more operations may comprise global only operations, local and global operations, local only operations, and non-principal operations.

The global only operations may comprise a Set Body operation for setting a fitting-target body.

The local and global operations may comprise a Set Textile operation and a Set Physics operation, wherein the Set Textile operation sets surface details of a given panel and the Set Physics operation sets physical parameters of a fabric constituting the given panel.

The local only operations may comprise operations for Replace Panel, Scale Panel, Replace Panel Fragment, Create Dart, Edit Dart, Pivot Dart, Crease Pleat, Create Turk, Create Gather, Import, and Extract.

The non-principal operations may comprise operations for Set Closure, Attach Panel, Set Cuff, Set Fastening, Create Seam Pocket, Create Lip Pocket, Create Continental Pocket, Create Belt Loop, Set Lapel, and Put Ornament.

The advantages of the present invention are: m (1) the method according to the invention provides a designer with a powerful tool; and (2) the method turns a painstaking manual work to a clean and simple programming-like work.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a diagram showing a situation where a garment is to be constructed for a standard male body;

FIG. 2 is a diagram showing that a customer is requested to select design elements for a shirt according to an embodiment of the invention;

FIG. 3 is a diagram showing that a customer is requested to select design elements for a jacket according to an embodiment of the invention;

FIG. 4 is a diagram showing that a customer is requested to select design elements for a vest according to an embodiment of the invention;

FIG. 5 is a diagram showing that a customer is requested to select design elements for a pair of pants according to an embodiment of the invention;

FIG. 6 is a diagram showing a principal panel and a non-principal panel;

FIG. 7 is screen shots showing three levels of cloth construction according to an embodiment of the invention;

FIG. 8 is a diagram showing a combinatorial level of a jacket designing;

FIG. 9 is an exemplary garment graph for a shirt according to an embodiment of the invention;

FIG. 10 is a screen shot showing a graph window and a garment window according to an embodiment of the invention;

FIG. 11 is a diagram showing a mark and a handle on a panel according to an embodiment of the invention;

FIG. 12 is screen shots showing a pattern window and a graph window according to an embodiment of the invention;

FIG. 13 is a diagram showing a prototype garment and garment graphs derived from the prototype garment according to an embodiment of the invention;

FIG. 14 is a diagram showing how to construct a garment graph according to an embodiment of the invention;

FIG. 15 is another diagram showing how to construct a garment graph according to an embodiment of the invention;

FIG. 16 is a garment graph with operations applied to a principal panel according to an embodiment of the invention;

FIG. 17 is a diagram showing an operation according to an embodiment of the invention;

FIG. 18 is a garment graph for shirt according to an embodiment of the invention; and

FIG. 19 is a garment graph for pants according to an embodiment of the invention.

### DETAILED DESCRIPTION EMBODIMENTS OF THE INVENTION

U.S. Patent App. Ser. No. 61/973,157 and U.S. patent application Ser. No. 14/187,119, filed Feb. 21, 2014 under the title “METHOD OF SMART GRADING BASED ON PARAMETERIZED DRAFT” by Applicant are hereby incorporated by reference.

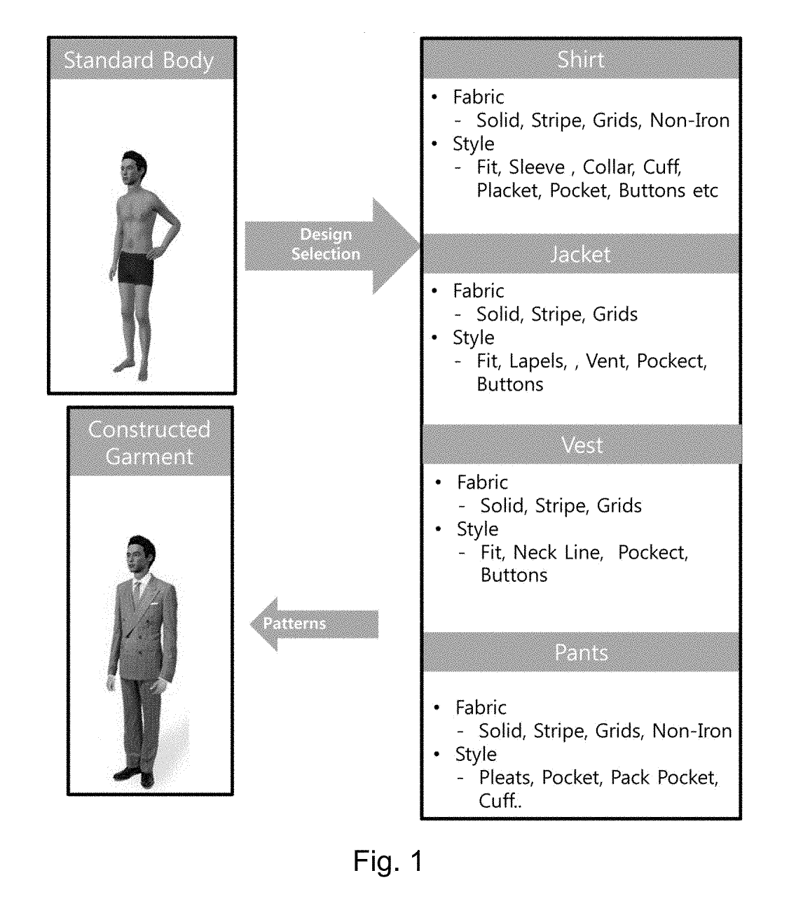

Let's imagine a shirt, jacket, vest, and pants need to be constructed for the standard male body, as depicted in FIG. 1.

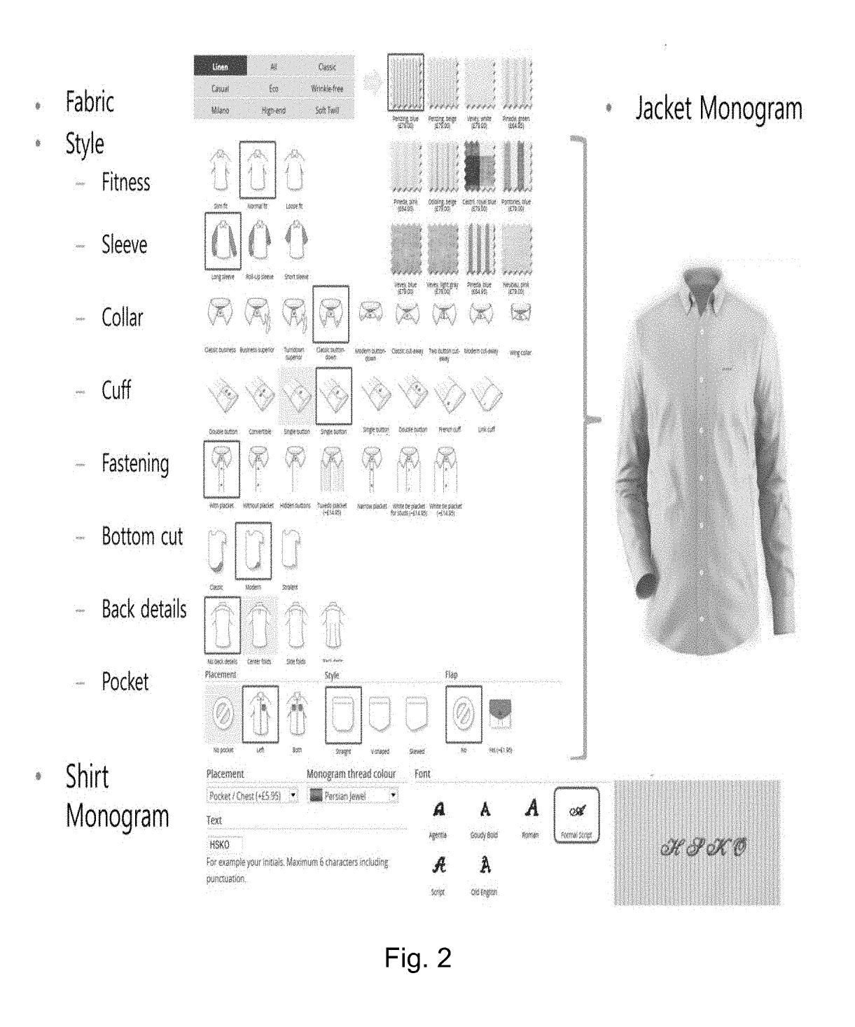

For example, in the shirt, for the case of custom production, usually the customer is asked to select the design elements shown in FIG. 2. The customer is first asked to select the fabric among the available choices.

Then the customer is asked to select the Fit, Sleeve, Collar, Cuff, Placket, Pocket, Buttons etc. among the available choices.

The customer can select the shirt monogram if applicable. It is impractical to prepare all the combinations of the above design elements beforehand, since there will be millions of possible cases, let alone the body size accommodation. That is the reason why the made-to-measure clothes are conventionally hand-constructed by the custom tailor.

This patent application proposes a new method to automatically construct the clothing that meets the requested design selections for the assumed standard body. (Further generalization to an arbitrary body is done with another propriety technique called the Draft-Space Warping.)

The proposed method, namely CCD-GG, automatically generates all the data for the shirt that fulfills the requested design selections. The data includes the patterns, seams, physical parameters of the fabrics, etc.

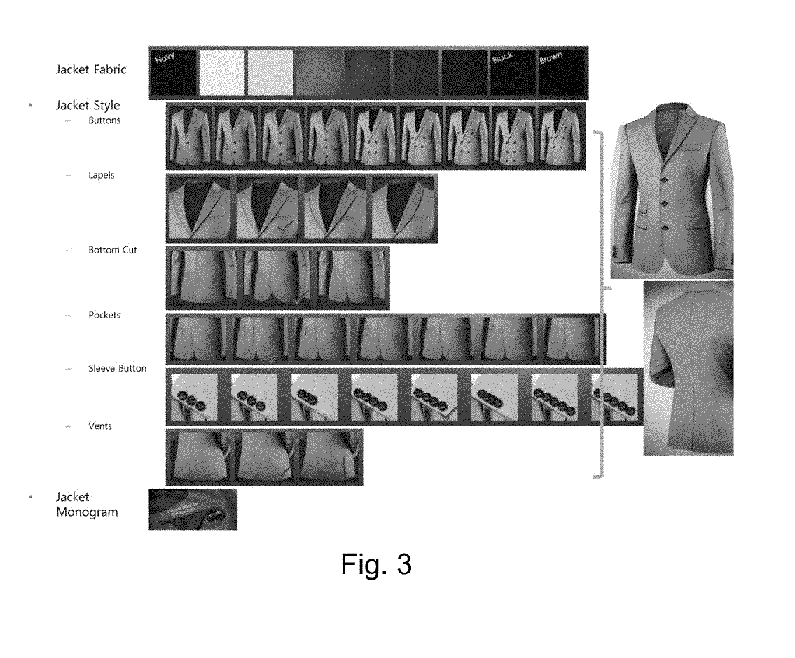

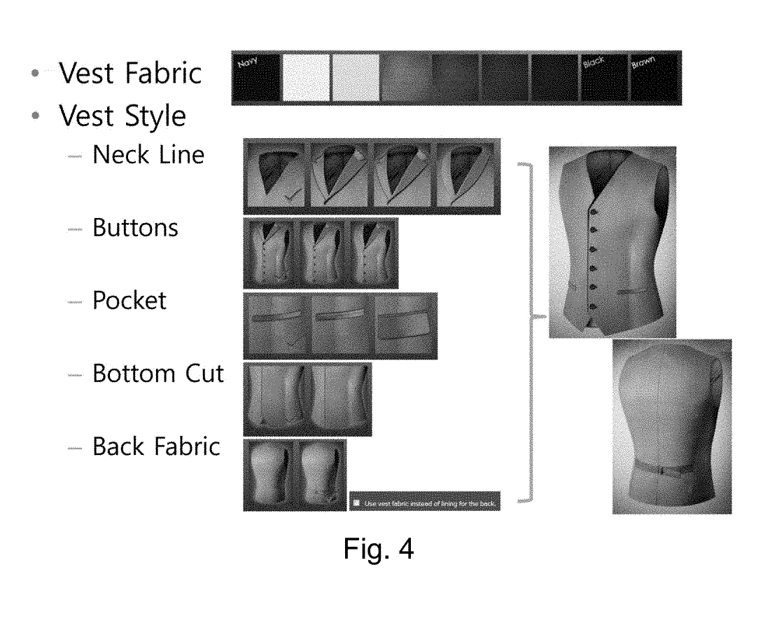

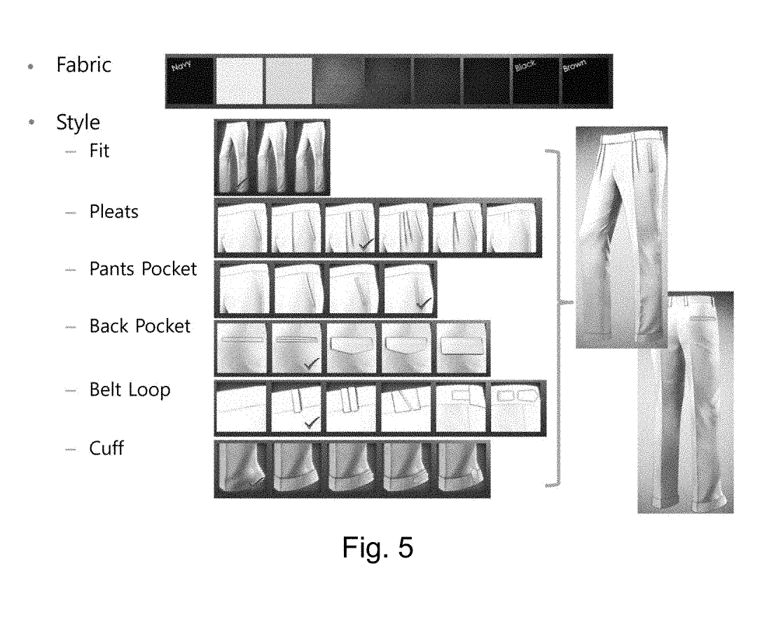

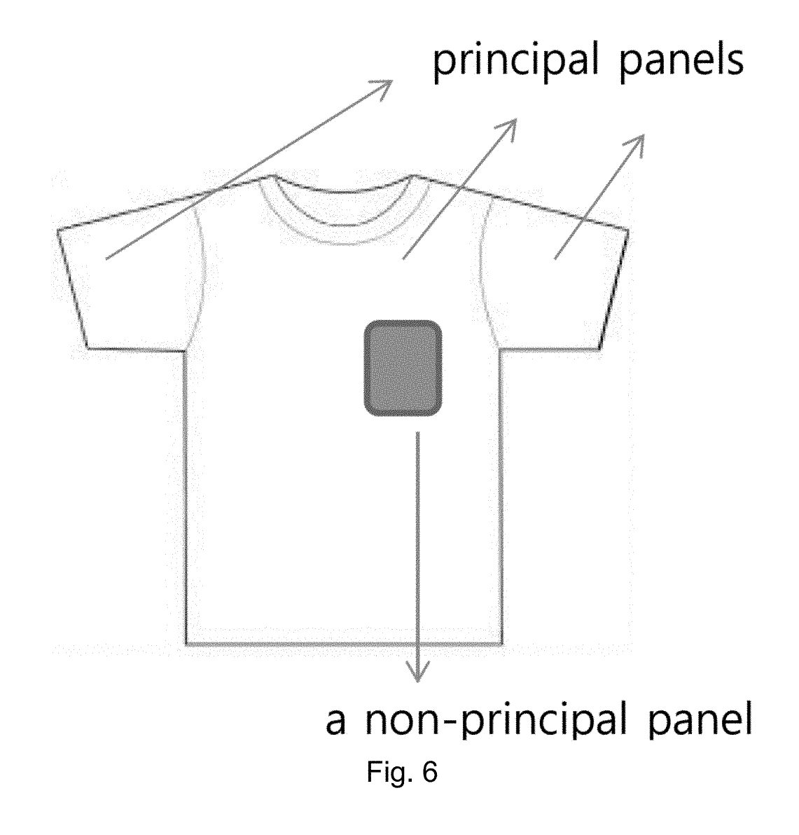

Similar process can apply to the jacket, vest, and pants. (FIGS. 3-5) Although the above is described for the shirt, jacket, vest, and pants for the male, CCD-GG can apply to other kinds of garments and gender.

An object of the invention is to provide a method for designing garments.

The key idea of this patent application are as follows.

The idea of using graphs to construct a garment: Here, graph is just a means to intuitively visualize the garment construction process; Essentially the same idea can be realized without using graphs but using other means (e.g., texts). Therefore, it is more accurate to say, the key idea of this patent application is to construct garment by programming, regardless of how the program is described.

Additional ideas how to effectively use GG: The idea of using GG to realize CCD. With GG, the idea of having three levels of abstraction for clothing construction, namely, the combinatorial level, the GG level, and the pattern-making level.

Additional ideas which are crucial for the implementation and practicality of GG.

The idea of decomposing a garment into principal and non-principal panels and seams: This decomposition, which sounds obvious, is crucial to make the implementation of the garment graph feasible and the resulting CCD-GG system practically useful.

The idea of starting the GG programming with already seamed (principal seams) panels, and the idea of maintaining those principal seams as operations are applied to the panels.

The idea of having different versions (namely, the pure version, the simulation version, the visualization version, and the manufacturing version) of the principal panel.

Other miscellaneous ideas related to GG: The idea for each operation to have the scope (local, global, local and global, and shadowing). The concept of scope is borrowed from the programming languages such as C or C++. But its use in GG programming has never been thought of before. The idea of adding marks and handles to align primitives (panels or drafts). The idea of interpreting the clicking of the central box as to compile the current GG and show its draping on the body. The idea of having the compound operation.

An aspect of the invention provides a method for manufacturing a garment.

FIGS. 2-5 are diagrams showing that a customer is requested to select design elements for shirt, jacket, vest, and pants according to an embodiment of the invention.

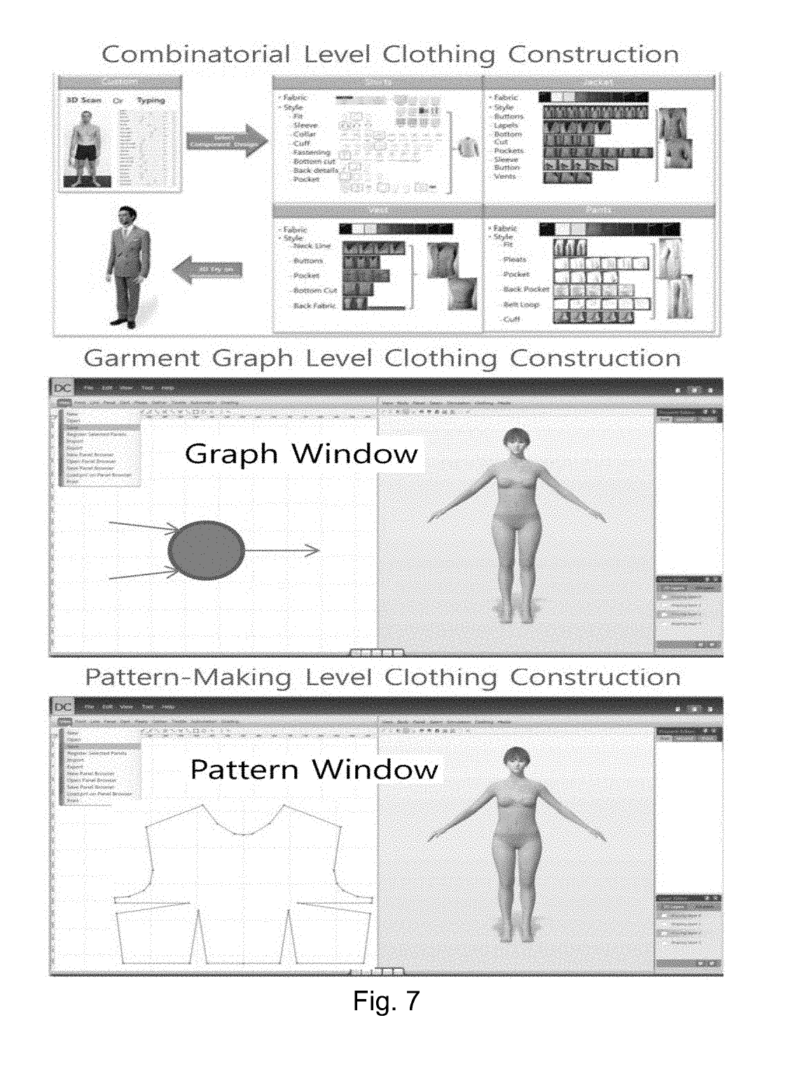

FIG. 7 is screen shots showing three levels of cloth construction according to an embodiment of the invention.

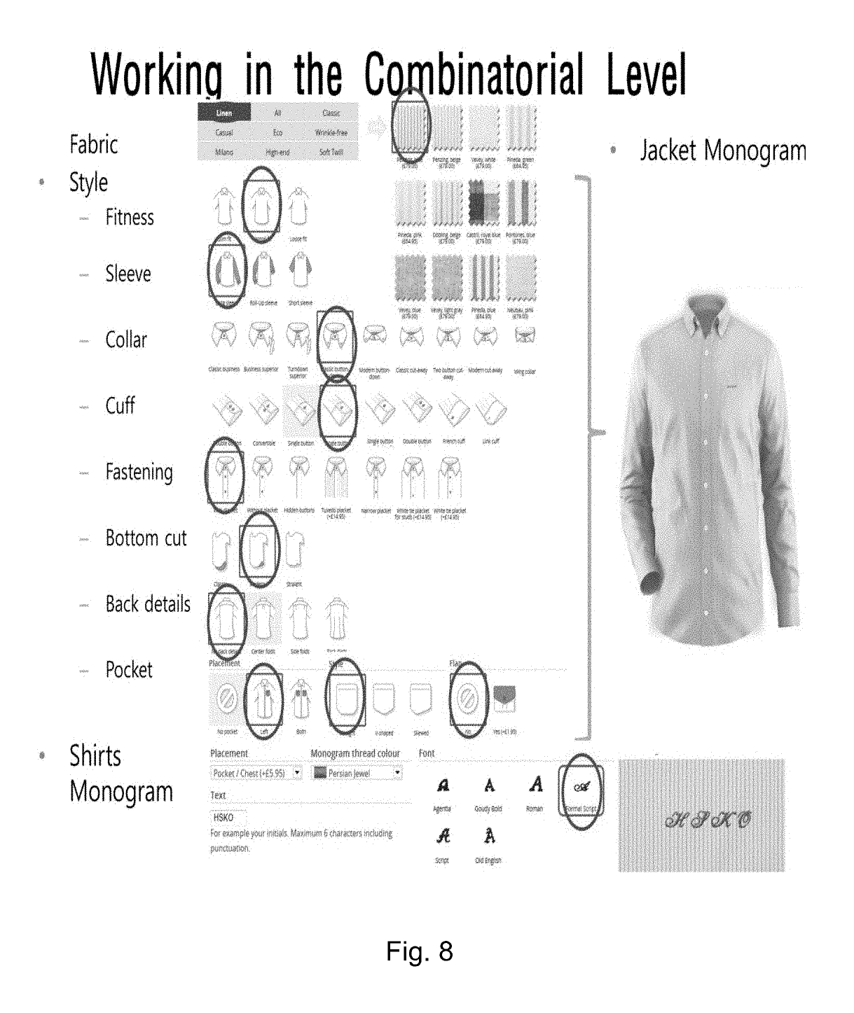

FIG. 8 is a diagram showing a combinatorial level of a jacket designing, in which the designer selects a desirable part from assets for each of the garment portions.

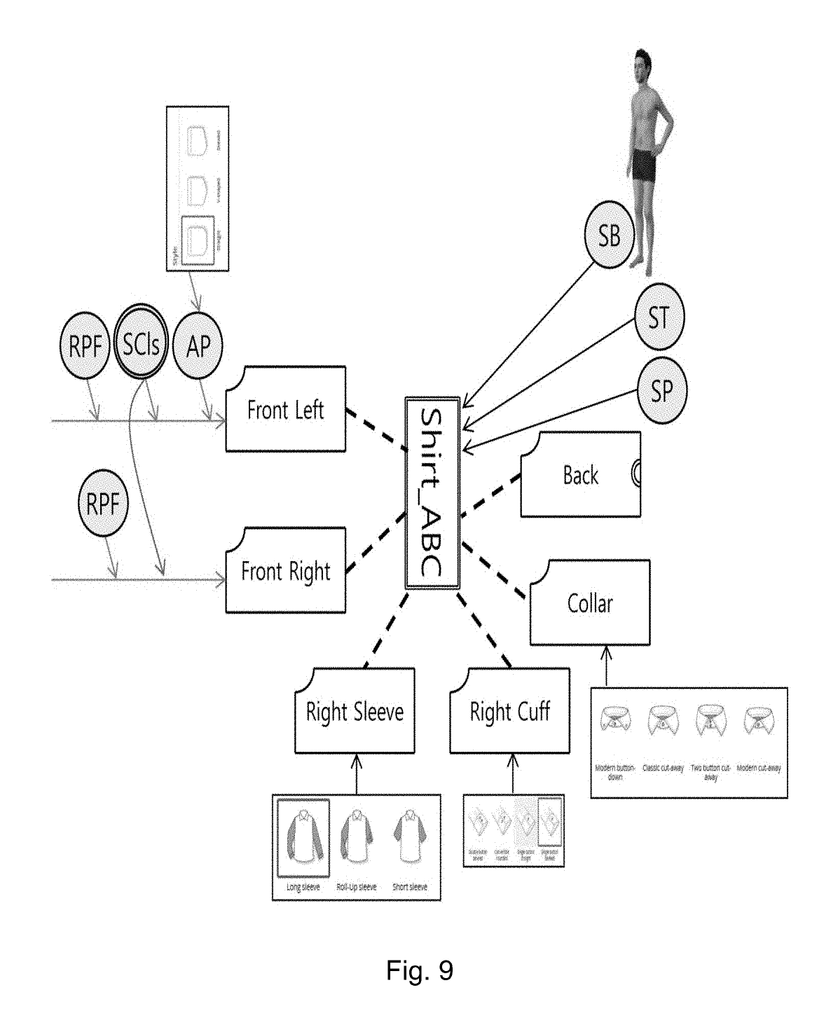

FIG. 9 is an exemplary garment graph for a shirt according to an embodiment of the invention, in which as the graph programming proceeds, the garment graph gets more and more complicated with added details to each of the principal panels.

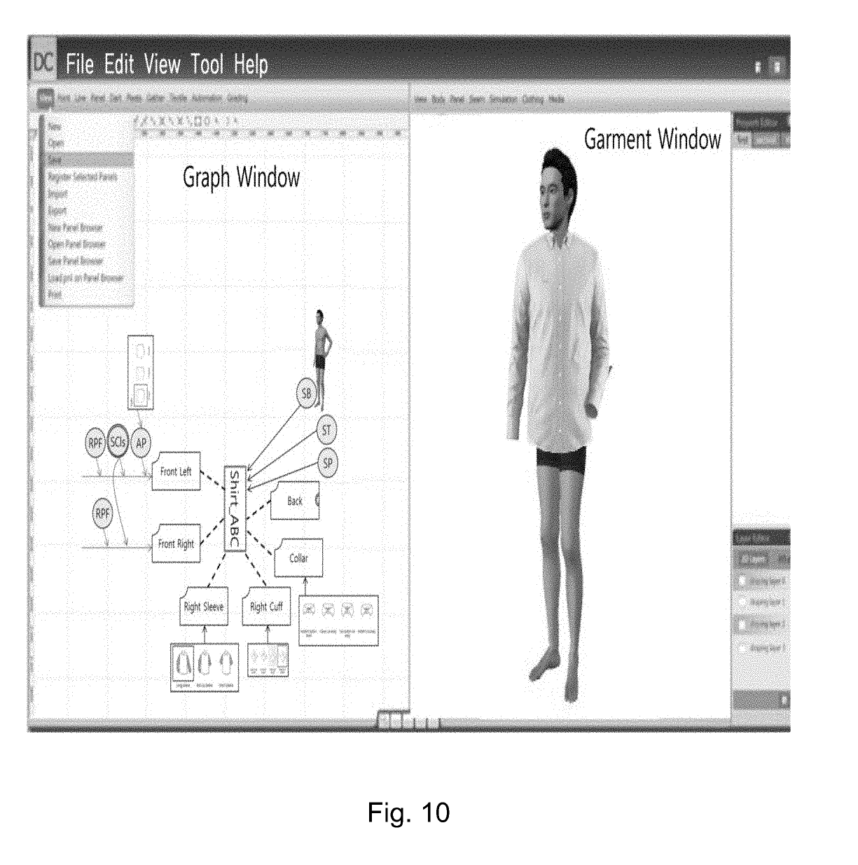

FIG. 10 is a screen shot showing a graph window and a garment window according to an embodiment of the invention. Editing of the garment graph is performed in the graph window, and the resultant garment can be viewed in the garment window on the right.

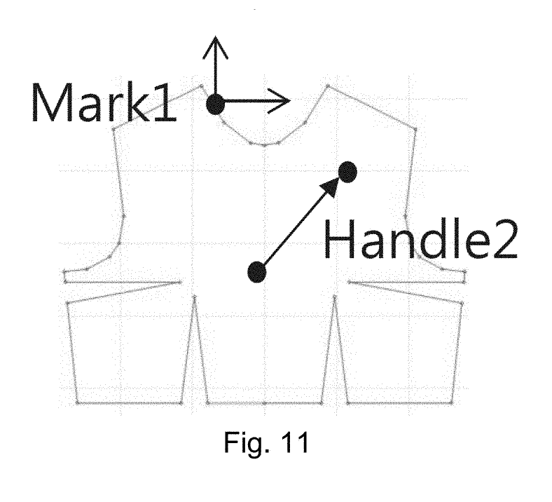

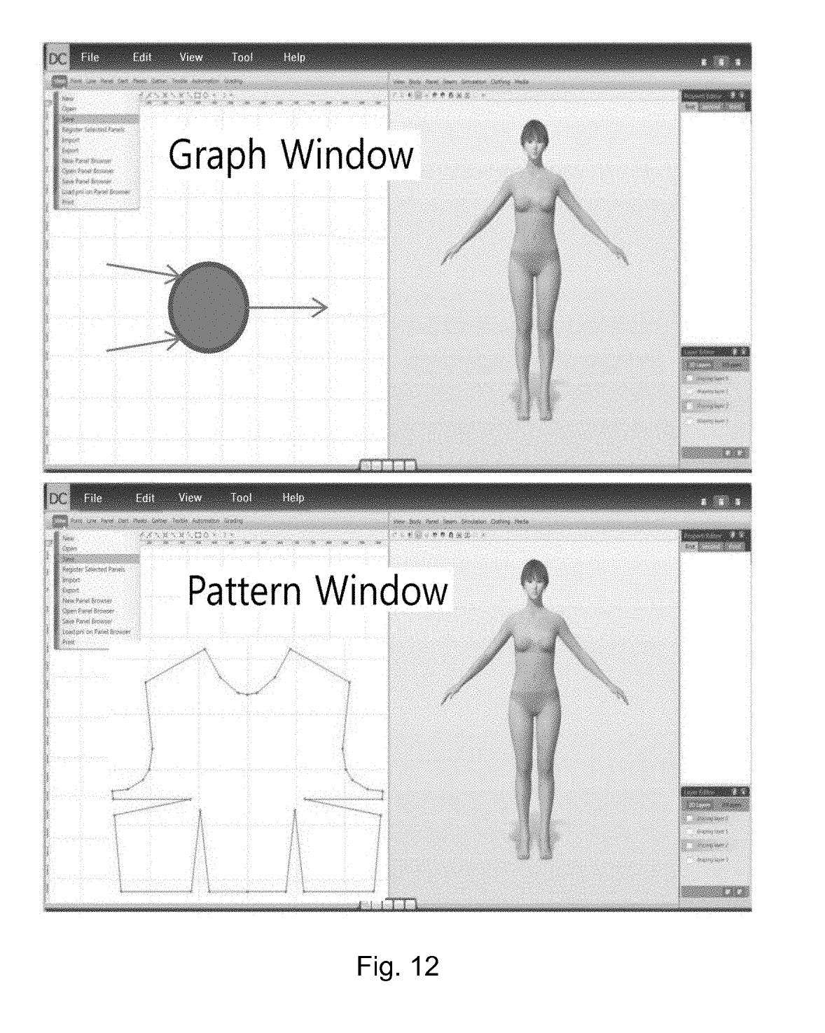

FIG. 12 is screen shots showing a pattern window and a graph window according to an embodiment of the invention. The left window may be used as either a pattern window or a graph window. The right window is used always for visualizing 3D garment.

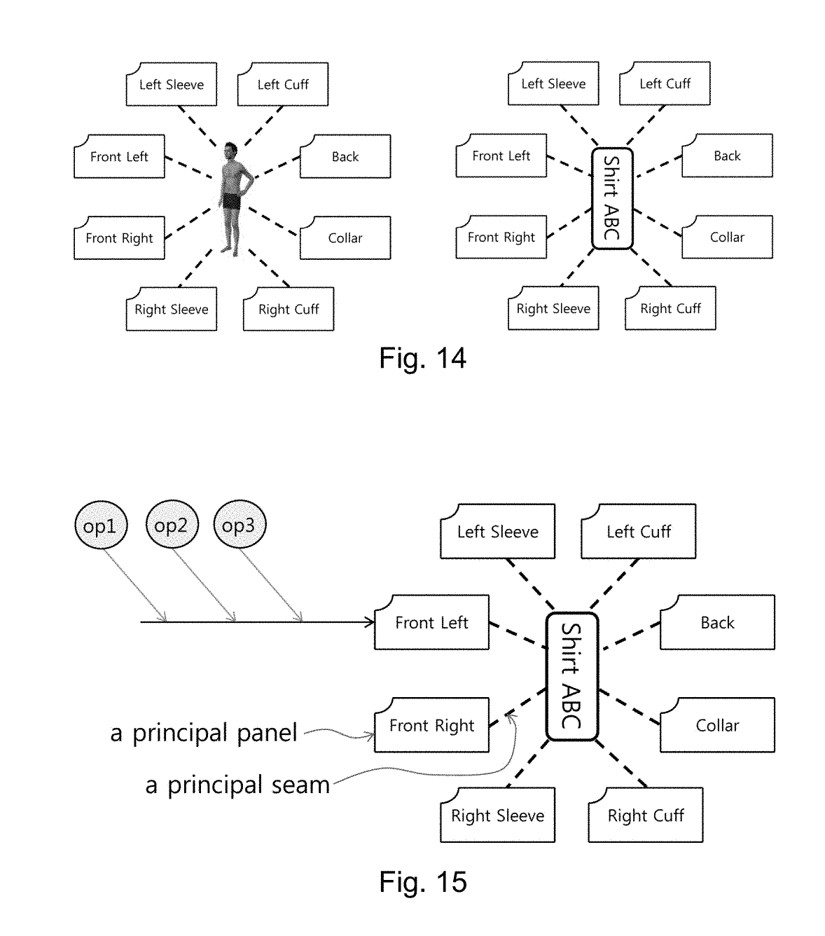

FIG. 14 is a diagram showing how to construct a garment graph according to an embodiment of the invention. Constructing a garment graph can start only when its prototype garment graph has been already prepared. In order to construct a prototype garment graph, it follows the conventional procedure of DC Suite garment construction: Pattern-making→panel creation→seam creation. That is, (1) Choose the menu “Output as Prototype Garment Graph”. DCS asks the name of the prototype garment. (For example, “Shirt”). (2) Then DCS saves the constructed prototype garment into a PGG file. The body used for the above construction is also remembered for possible future reference. (3) When a PGG file is read into DCS, DCS asks a more specific name (e.g., Shirt ABC). Then the above PGG is set to the initial garment graph for Shirt ABC, to which you will make modifications to create your own design. Note that when a PGG file is read, DCS creates a GG (initial version), not a PGG.

FIG. 15 is another diagram showing how to construct a garment graph according to an embodiment of the invention. A principal panel is Panels comprising the prototype garment graph are called the principal panels, and a non-principal panels can be added to the garment graph (through operations). A principal seam is seams created between the principal panels are called the principal seams. Non-principal seams can be added to the garment graph (through operations). Once the construction of a prototype garment graph is done for a prototype garment (e.g., shirt), then a garment graph can be created by copying the prototype garment graph. Constructing the prototype garment graph is expected to be done by the pattern expert. A set of prototype garment graphs can be provided as DCS asset.

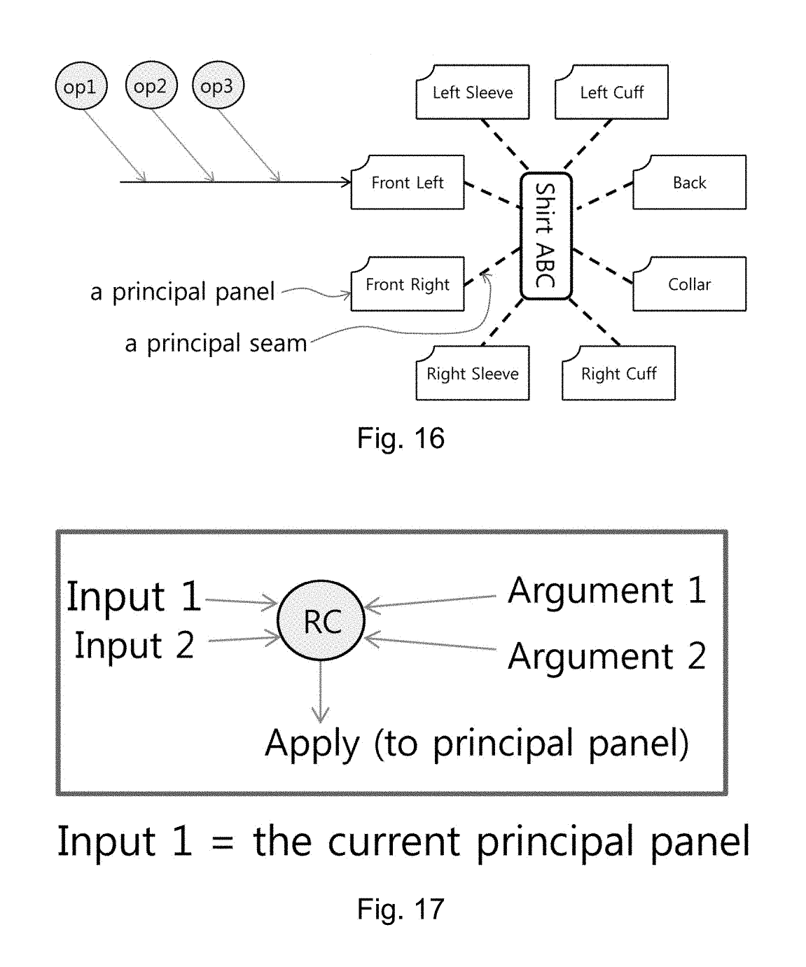

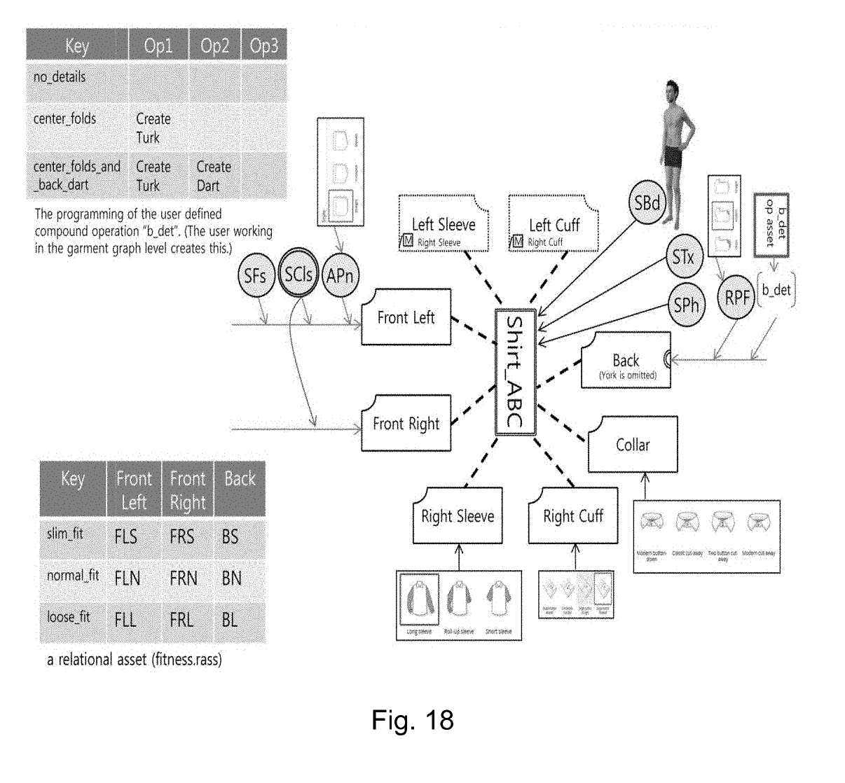

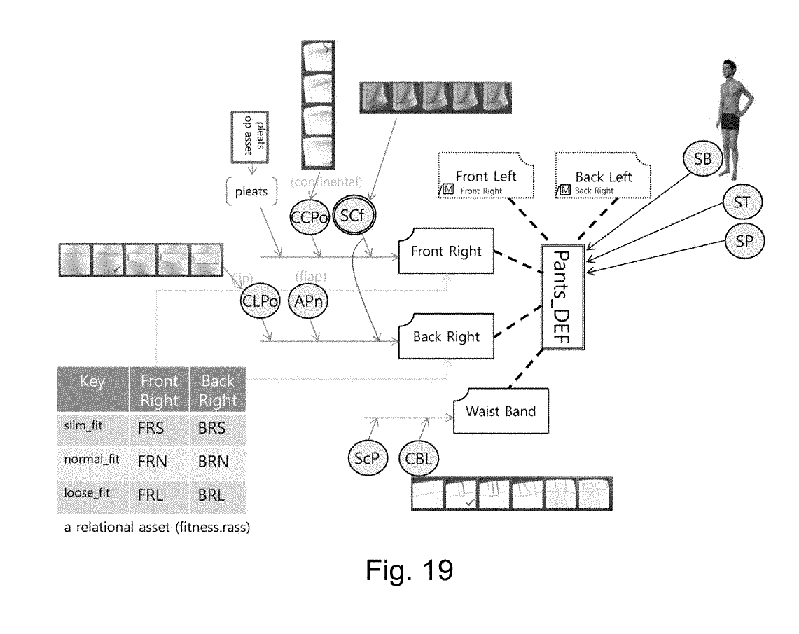

FIG. 16 is a garment graph with operations applied to a principal panel according to an embodiment of the invention. Operations can be applied to each principal panel of the GG. The operations are executed in the given order (from left to right). The order is important. Each operation specifies how a panel is modified/replaced.

FIG. 17 is a diagram showing an operation according to an embodiment of the invention. In certain embodiments of the invention, the circle (with 2˜4 letters in it) stands for an operation, and arrows are input, arguments, apply Input: panel or draft. (draft=a set of points and lines). There can be one (input 2) or zero inputs. The current principal panel is regarded as input 1. Argument 1 is interactively selected stuff, i.e., a set of selections from the panel/draft, selection among given options, etc., and Argument 2 is typed in values, e.g., the dart amount, and Apply shows that the operation is applied to the panel.

The method comprises steps for:

providing a database or an asset for a garment, wherein the asset comprises a plurality of choices for each of a plurality of operands for the garment;

providing at least one prototype garment for the garment including principal panels, wherein the prototype garment is configured to fit a standard body;

uploading the prototype garment on a graph window by selecting and associating a principal panel from the asset for each part of the garment so as to construct a garment graph using graphical representations for principal panels or editing the prototype garment by selecting and associating a principal panel from the asset for each part of the garment;

selecting from corresponding assets and adding one or more non-principal panels to the principal panels;

programming the garment graph by associating one or more predetermined operations to be applied to each of the principal panels based on a fitting-target body;

compiling the programmed garment graph and constructing the garment; and

displaying the constructed garment as fitted a mannequin in a garment window.

The method according to the present invention may be performed in an information processing device such as a computer. And, performing of each of the steps may be related to one or more information processing in the computer and associated auxiliary devices including various input and output devices.

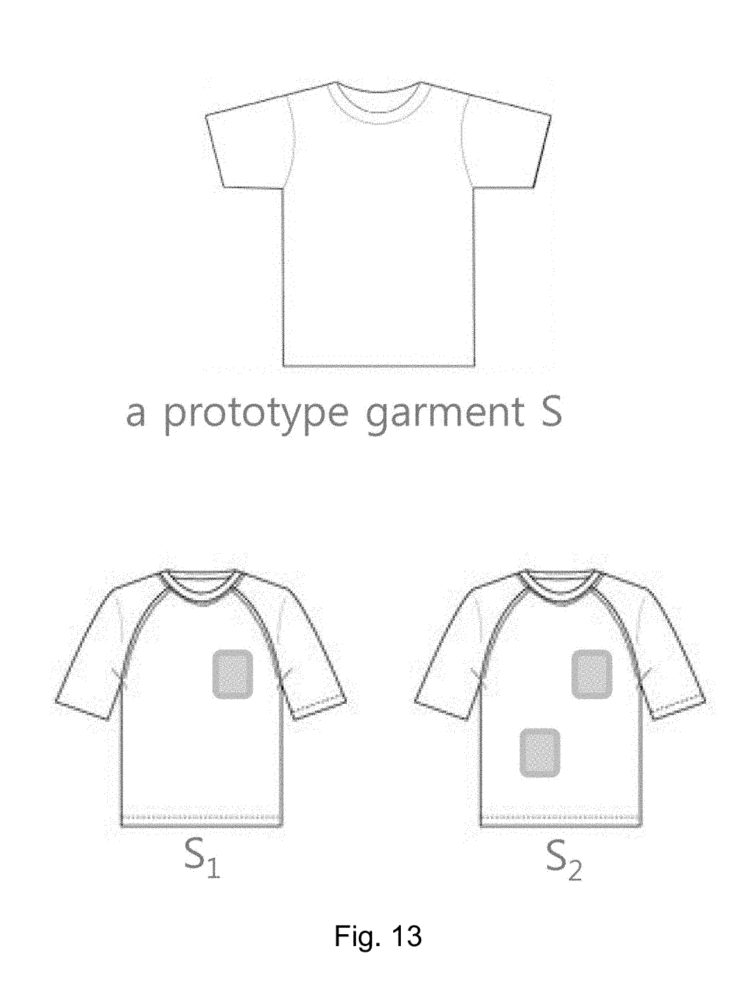

In FIGS. 2-5, for example, all the assets may be stored in the computer or another memory device, and displayed on a display, allowing a user of the method or a garment designer to select one out of the choices as indicated by check marks. The prototype garment is shown in FIG. 13, and to the prototype garment are added the pockets (S1 and S2).

The method may further comprise a step for adding a GUI on top of the compiled garment graph before the step for displaying. Therefore, the constructed garment can be displayed on a screen as shown in FIG. 1.

The method may further comprise a step for adding or editing marks and handles to the panels for combining with drafts and assets. A mark comprises a 2D coordinate frame and configured for aligning panel/draft, panel/panel, or draft/draft, and a handle is an ordered pair of two marks and configured for assigning a directional line between the two marks as shown in FIG. 11.

Each of the principal panel may include a pure version omitting details, a simulation version, a visualization version, and a manufacturing version having every detail of the principal panel.

The step of programming the garment graph may comprise to perform a smart grading technique for accommodating a body difference between the standard body and the fitting-target body on an information processing device. The smart grading technique has been disclosed in U.S. patent application Ser. No. 14/187,119, filed Feb. 21, 2014 under the title “METHOD OF SMART GRADING BASED ON PARAMETERIZED DRAFT” by Applicant, which has been hereby incorporated by reference.

The principal panels may be visualize all the time, and the non-principal panels are visualized selectively.

The method may further comprise a step for pattern-making and manufacturing the garment based on the constructed garment having the manufacturing version of principal panels and non-principal panels.

The garment graph may comprise a center box for representing the garment and configured for being clickable for compiling, corresponding principal panels connected to and associated with the center box graphically, corresponding non-principal panels connected and associated with corresponding principal panel graphically, and corresponding operands defining how associated panel is modified or replaced.

The operand may be associated with inputs, arguments, and outputs using arrows.

The step for compiling may comprise steps for producing a simulation version of resultant garment, producing a visualization version to show the simulated version, and saving a manufacturing version into a file for the information processing device using a garment graph compiler.

The one or more operations may comprise global only operations, local and global operations, local only operations, and non-principal operations.

The global only operations may comprise a Set Body operation for setting a fitting-target body.

The local and global operations may comprise a Set Textile operation and a Set Physics operation, wherein the Set Textile operation sets surface details of a given panel and the Set Physics operation sets physical parameters of a fabric constituting the given panel.

The local only operations may comprise operations for Replace Panel, Scale Panel, Replace Panel Fragment, Create Dart, Edit Dart, Pivot Dart, Crease Pleat, Create Turk, Create Gather, Import, and Extract.

The non-principal operations may comprise operations for Set Closure, Attach Panel, Set Cuff, Set Fastening, Create Seam Pocket, Create Lip Pocket, Create Continental Pocket, Create Belt Loop, Set Lapel, and Put Ornament.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A method for designing garments, the method comprising steps for:
providing a database or an asset for a garment, wherein the asset comprises a plurality of choices for each of a plurality of operands for the garment;
providing at least one prototype garment for the garment including principal panels, wherein the prototype garment is configured to fit a standard body;
uploading the prototype garment on a graph window by selecting and associating a principal panel from the asset for each part of the garment so as to construct a garment graph using graphical representations for principal panels or editing the prototype garment by selecting and associating a principal panel from the asset for each part of the garment;
selecting from corresponding assets and adding one or more non-principal panels to the principal panels;
programming graphically the garment graph by associating one or more predetermined operations to be applied to each of the principal panels based on a fitting-target body;
compiling the programmed garment graph and constructing the garment; and
displaying the constructed garment as fitted a mannequin in a garment window.

2. The method of claim 1, further comprising a step for adding a GUI on top of the compiled garment graph before the step for displaying.

3. The method of claim 1, further comprising a step for adding or editing marks and handles to the panels for combining with drafts and assets, wherein a mark comprises a 2D coordinate frame and configured for aligning panel/draft, panel/panel, or draft/draft, and wherein a handle is an ordered pair of two marks and configured for assigning a directional line between the two marks.

4. The method of claim 1, wherein each of the principal panel includes a pure version omitting details, a simulation version, a visualization version, and a manufacturing version having every detail of the principal panel.

5. The method of claim 1, wherein the step of programming the garment graph comprises to perform a smart grading technique for accommodating a body difference between the standard body and the fitting-target body on an information processing device.

6. The method of claim 1, wherein the principal panels are visualize all the time, and the non-principal panels are visualized selectively.

7. The method of claim 6, further comprising a step for pattern-making and manufacturing the garment based on the constructed garment having the manufacturing version of principal panels and non-principal panels.

8. The method of claim 1, wherein the garment graph comprises a center box for representing the garment and configured for being clickable for compiling, corresponding principal panels connected to and associated with the center box graphically, corresponding non-principal panels connected and associated with corresponding principal panel graphically, and corresponding operands defining how associated panel is modified or replaced.

9. The method of claim 8, wherein the operand is associated with inputs, arguments, and outputs using arrows.

10. The method of claim 1, wherein the step for compiling comprises steps for producing a simulation version of resultant garment, producing a visualization version to show the simulated version, and saving a manufacturing version into a file for the information processing device using a garment graph compiler.

11. The method of claim 1, wherein the one or more operations comprise global only operations, local and global operations, local only operations, and non-principal operations.

12. The method of claim 11, wherein the global only operations comprise a Set Body operation for setting a fitting-target body.

13. The method of claim 11, wherein the local and global operations comprise a Set Textile operation and a Set Physics operation, wherein the Set Textile operation sets surface details of a given panel and the Set Physics operation sets physical parameters of a fabric constituting the given panel.

14. The method of claim 11, wherein the local only operations comprise operations for Replace Panel, Scale Panel, Replace Panel Fragment, Create Dart, Edit Dart, Pivot Dart, Crease Pleat, Create Turk, Create Gather, Import, and Extract.

15. The method of claim 11, wherein the non-principal operations comprise operations for Set Closure, Attach Panel, Set Cuff, Set Fastening, Create Seam Pocket, Create Lip Pocket, Create Continental Pocket, Create Belt Loop, Set Lapel, and Put Ornament.
